(19) United States
(12) Patent Application Publication
(10) Pub. No.: US 2007/0016321 A1
(43) Pub. Date: Jan. 18, 2007

(54) Method for screening risk quality semiconductor products

(76) Inventor: Dieter Rathei, Graz (AT)

Correspondence Address: BARRY DOVE PATENT SERVICES, INC., 610 MANDERLEY RUN, LAKE MARY, FL, 32746, US

(21) Appl. No.: 11/485,477

(22) Filed: Jul. 12, 2006

Related U.S. Application Data
(60) Provisional application No. 60/700,221, filed on Jul. 18, 2005.

(51) Int. Cl. G06F 19/00

(52) U.S. Cl. 700/109; 438/14

(57) ABSTRACT

Method of forming a quality passing set of semiconductor products. A parameter is tested in a plurality of semiconductor products. A specification passing set of semiconductor products is formed from semiconductor products in the plurality of semiconductor products. The specification passing set of semiconductor products have a parameter value of the parameter within a specification range. An upper and a lower percentile value are calculated. A weighted benchmark step distance is calculated. The calculation of the weighted benchmark step distance includes dividing a bulk distribution range distance by a bulk distribution population size to calculate a benchmark step distance. The weighted benchmark step distance is the product of the benchmark step distance and a step weighting number. A lower bound of the specification passing set of parameter values is screened. An upper bound of the specification passing set of parameter values is also screened.

This application claims the benefit of U.S. Provisional Application No. 60/700,221, filed on Jul. 18, 2005, entitled METHODS FOR MONITORING, SCREENING, AND AGGREGATING INTEGRATED CIRCUIT TEST DATA FOR USE IN EVALUATING SEMICONDUCTOR MANUFACTURING PROCESSES, which application is hereby incorporated herein by reference.

### TECHNICAL FIELD

The present invention generally relates to semiconductor manufacturing. In one aspect it relates more particularly to the testing of semiconductors and monitoring trends in semiconductor manufacturing.

### BACKGROUND

A semiconductor test known in the art as a functional test is a test in which manufactured semiconductor chips are electrically probed and tested for a parameter (e.g., voltage, current, resistance, and power). The test consists of a sequence of single tests, most of which create a single measurement value. This measurement value is then compared against a predetermined specification range. A specification range is typically a range of values between a lower and an upper specification limit. Devices for which all test measurement values are inside the specification range are determined to have passed the functional test, and may be shipped to an end user.

However, a typical frequency distribution of functional test measurements in a specification range may include a bulk distribution and smaller outlying measurements. For example, a typical distribution of functional test measurements inside a specification range may include a larger portion of the test measurements distributed closely about a desired target test measurement. The same typical distribution of functional test measurements may also include some outlying measurements or groups of measurements that differ significantly from the bulk distribution of test measurements and from the target test measurement. Although these outlying measurements are within a specification range, they differ sufficiently from the bulk distribution and from the target test measurement to raise suspicion as to their quality, and thus pose a quality risk.

Existing methods to screen quality risk parts inside a specification range may rely on statistical approximations that are unsuited to model distributions of semiconductor functional test results. For example, an existing method may apply a frequency distribution known as the Normal distribution, which is also called the Gaussian distribution. The center of the Normal distribution might be aligned with the desired target test measurement and any parts having test measurements beyond 3 sigma above or below the center of the Normal distribution (e.g., above the 99.9 percentile and below the 0.1 percentile) may be rejected.

There are several disadvantages to this approach. A first disadvantage is that a Normal distribution or other well-known distributions (e.g., a Poisson distribution) may not suitably approximate or model the frequency distributions of semiconductor functional test results for a given parameter. Incorrectly modeling a distribution of semiconductor functional test measurements may introduce error into the testing process. For example, a semiconductor part that has a test measurement inside the six sigma limits of a Normal distribution but which deviates sufficiently from the bulk distribution to pose a quality risk may incorrectly pass the functional test. A quality risk semiconductor part that incorrectly passes function test may fail during use, possibly resulting in reduced product quality and lost revenue. In another example, a semiconductor part that has a functional test measurement outside the six sigma limits of a Normal distribution but which is acceptable in similarity to the majority of test measurements may be incorrectly rejected. Semiconductor parts that meet quality control requirements but which are rejected at functional test may unnecessarily result in lower yields and decreased revenue.

Hence, there is a need for a method of screening risk quality semiconductor products that does not employ inaccurate or unsuitable statistical approximations. There is also a need for a method of screening risk quality semiconductor products that can discriminate quality risk parts from true quality parts.

### SUMMARY OF THE INVENTION

The problems and needs outlined above may be addressed by embodiments of the present invention. In accordance with one aspect of the present invention, a method of forming a quality passing set of semiconductor products is provided. This method includes the following steps described in this paragraph. The order of the steps may vary, may be sequential, may overlap, may be in parallel, and combinations thereof, if not otherwise stated. A parameter is tested in a plurality of semiconductor products. A specification passing set of semiconductor products is formed from semiconductor products in the plurality of semiconductor products that have a parameter value of the parameter within a specification range. Quality risk semiconductor products are screened from the specification passing set of semiconductor products to form the quality passing set of semiconductor products. The screening of quality risk semiconductor products includes calculating an upper percentile parameter value. The upper percentile parameter value is at an upper percentile of the specification passing set of parameter values. The screening of quality risk semiconductor products further includes calculating a lower percentile parameter value. The lower percentile parameter value is at a lower percentile of the specification passing set of parameter values. The screening of quality risk semiconductor products still further includes calculating a weighted benchmark step distance. The calculation of the weighted benchmark step distance includes calculating a bulk distribution range distance. The bulk distribution range distance is a distance between the upper percentile parameter value and the lower percentile parameter value. The calculation of the weighted benchmark step distance further includes calculating a bulk distribution population size. The calculation of the weighted benchmark step distance still further includes calculating a benchmark step distance. The benchmark step distance is the bulk distribution range distance divided by the bulk distribution population size. The calculation of the weighted benchmark step distance yet further includes multiplying the benchmark step distance by a step weighting number. The screening of quality risk semiconductor products yet further includes screening a lower bound of the specification passing set of parameter values. The screening of the lower bound of the specification passing set of parameter values includes forming a set of lower bound parameter values. The set of lower bound parameter values includes parameter values of the specification passing set of parameter values that are at and below the lower percentile. The screening of the lower bound of the specification passing set of parameter values further includes sorting the set of lower bound parameter values. The set of lower bound parameter values are sorted from a largest lower bound parameter value to a smallest lower bound parameter value. The screening of the lower bound of the specification passing set of parameter values still further includes calculating a lower bound step distance between each lower bound parameter value in the set of lower bound parameter values and a next smaller lower bound parameter value. The calculations of lower bound step distances between each lower bound parameter value and a next smaller lower bound parameter value begin with the largest lower bound parameter value. Semiconductor products in the specification passing set of semiconductor products that have a parameter value equal to or less than the next smaller lower bound parameter value are removed from the specification passing set of semiconductor products if the lower bound step distance is greater than the weighted benchmark step distance. The screening of quality risk semiconductor products yet further includes screening an upper bound of the specification passing set of parameter values. The screening of the upper bound of the specification passing set of parameter values includes forming a set of upper bound parameter values. The set of upper bound parameter values includes parameter values of the specification passing set of parameter values that are at and above the upper percentile. The screening of the upper bound of the specification passing set of parameter values includes sorting the set of upper bound parameter values. The set of upper bound parameter values are sorted from a smallest lower bound parameter value to a largest lower bound parameter value. The screening of the upper bound of the specification passing set of parameter values further includes calculating an upper bound step distance between each upper bound parameter value in the set of upper bound parameter values and a next larger upper bound parameter value. The calculations of upper bound step distances between each upper bound parameter value and a next larger upper bound parameter value begin with the smallest upper bound parameter value. Semiconductor products in the specification passing set of semiconductor products that have a parameter value equal to or greater than the next larger upper bound parameter value are removed from the specification passing set of semiconductor products if the upper bound step distance is greater than the weighted benchmark step distance.

This paragraph describes some embodiments of the aspect of the present invention described in the immediately preceding paragraph. The step weighting number may be a preselected number selected from the group consisting of 1.3, 0.856, −0.214, and −2. The lower percentile and the upper percentile may be preselected numbers. The specification range may be a range of values between a preselected upper specification limit and a preselected lower specification limit. The lower percentile and the upper percentile may be preselected numbers. A lower percentile distance between the lower percentile and 0% may be different than an upper percentile distance between the upper percentile and 100%. The lower percentile may be 3% and the upper percentile may be 97%. The upper percentile may be the lower percentile subtracted from 100%. The upper percentile may be 100%. The lower percentile may be 0%. The testing may be a final chip test. The testing may be a wafer test prior to wafer sort. The bulk distribution population size may be a number of semiconductor products in the specification passing set of semiconductor products that have parameter values between the upper percentile parameter value and the lower percentile parameter value. The bulk distribution population size may be a size of the specification passing set of semiconductor products multiplied by a difference of the lower percentile subtracted from the upper percentile.

In accordance with another aspect of the present invention, a method of forming a quality passing set of semiconductor products is provided. This method includes the following steps described in this paragraph. The order of the steps may vary, may be sequential, may overlap, may be in parallel, and combinations thereof, if not otherwise stated. A parameter is tested in a plurality of semiconductor products. A specification passing set of semiconductor products is formed from semiconductor products in the plurality of semiconductor products that have a parameter value of the parameter within a specification range. Quality risk semiconductor products are screened from the specification passing set of semiconductor products to form the quality passing set of semiconductor products. The screening of quality risk semiconductor products includes calculating an upper percentile parameter value. The upper percentile parameter value is at an upper percentile of the specification passing set of parameter values. The screening of quality risk semiconductor products further includes calculating a lower percentile parameter value. The lower percentile parameter value is at a lower percentile of the specification passing set of parameter values. The screening of quality risk semiconductor products still further includes calculating a weighted benchmark step distance. The calculation of the weighted benchmark step distance includes calculating a bulk distribution set of parameter values. The bulk distribution set of parameter values includes parameter values from the specification passing set that are in a range between the upper percentile parameter value and the lower percentile parameter value. The calculation of the weighted benchmark step distance still further includes calculating a set of bulk distribution step distances. The set of bulk distribution step distances includes distances between each parameter value in the set of bulk distribution parameter values and an adjacent parameter value also in the set of bulk distribution parameter values. The calculation of the weighted benchmark step distance yet further includes multiplying a largest step distance in the set of bulk distribution step distances by a step weighting number to define the weighted benchmark step distance. The screening of quality risk semiconductor products yet further includes screening a lower bound of the specification passing set of parameter values. The screening of the lower bound of the specification passing set of parameter values includes forming a set of lower bound parameter values. The set of lower bound parameter values includes parameter values of the specification passing set of parameter values that are at and below the lower percentile. The screening of the lower bound of the specification passing set of parameter values includes sorting the set of lower bound parameter values. The set of lower bound parameter values are sorted from a largest lower bound parameter value to a smallest lower bound parameter value. The screening of the lower bound of the specification passing set of parameter values further includes calculating a lower bound step distance between each lower bound parameter value in the set of lower bound parameter values and a next smaller lower bound parameter value. The calculations of lower bound step distances between each lower bound parameter value and a next smaller lower bound parameter value begin with the largest lower bound parameter value. Semiconductor products in the specification passing set of semiconductor products that have a parameter value equal to or less than the next smaller lower bound parameter value are removed from the specification passing set of semiconductor products if the lower bound step distance is greater than the weighted benchmark step distance. The screening of quality risk semiconductor products yet further includes screening an upper bound of the specification passing set of parameter values. The screening of the upper bound of the specification passing set of parameter values includes forming a set of upper bound parameter values. The set of upper bound parameter values includes parameter values of the specification passing set of parameter values that are at and above the upper percentile. The screening of the upper bound of the specification passing set of parameter values includes sorting the set of upper bound parameter values. The set of upper bound parameter values are sorted from a smallest lower bound parameter value to a largest lower bound parameter value. The screening of the upper bound of the specification passing set of parameter values further includes calculating an upper bound step distance between each upper bound parameter value in the set of upper bound parameter values and a next larger upper bound parameter value. The calculations of upper bound step distances between each upper bound parameter value and a next larger upper bound parameter value begin with the smallest upper bound parameter value. Semiconductor products in the specification passing set of semiconductor products that have a parameter value equal to or greater than the next larger upper bound parameter value are removed from the specification passing set of semiconductor products if the upper bound step distance is greater than the weighted benchmark step distance.

In accordance with yet another aspect of the present invention, a method of screening quality risk semiconductor products is provided. This method includes the following steps described in this paragraph. The order of the steps may vary, may be sequential, may overlap, may be in parallel, and combinations thereof, if not otherwise stated. A parameter is tested in a plurality of semiconductor products. A specification passing set of semiconductor products is formed from semiconductor products in the plurality of semiconductor products. The semiconductor products in the specification passing set of semiconductor products have a parameter value of the parameter within a specification range. A lower percentile parameter value is calculated in the specification passing set of parameter values. The lower percentile parameter value is at a lower percentile of the specification passing set of parameter values. A benchmark step distance is calculated. A lower bound of the specification passing set of parameter values is screened. The screening of the lower bound of the specification passing set of parameter values includes the formation of a set of lower bound parameter values. The parameter values in the set of lower bound parameter values are at and below the lower percentile. The screening of the lower bound of the specification passing set of parameter values further includes sorting the set of lower bound parameter values from a largest lower bound parameter value to a smallest lower bound parameter value. The screening of the lower bound of the specification passing set of parameter values still further includes detecting lower bound step distances that are greater than the weighted benchmark step distance. The detecting lower bound step distances includes for each lower bound parameter value in the set of lower bound parameter values and beginning with the largest lower bound parameter value, calculating a lower bound step distance between the each lower bound parameter value and a next smaller lower bound parameter value. The detecting lower bound step distances further includes the removal of semiconductor products that have a parameter value equal to or less than the next smaller lower bound parameter value from the specification passing set of semiconductor products if the lower bound step distance is greater than the weighted benchmark step distance.

This paragraph describes some embodiments of the aspect of the present invention described in the immediately preceding paragraph. The benchmark step distance may be a weighted benchmark step distance, and the weighted benchmark step distance may be the benchmark step distance multiplied by a step weighting number. An upper bound of the specification passing set of parameter values may be screened. The screening of the upper bound of the specification passing set of parameter values may include the formation of a set of upper bound parameter values. The parameter values in the set of upper bound parameter values may be at and above the upper percentile parameter value. The screening of the upper bound of the specification passing set of parameter values may further include sorting the set of upper bound parameter values from a smallest upper bound parameter value to a largest upper bound parameter value. The screening of the upper bound of the specification passing set of parameter values may still further include detecting upper bound step distances that may be greater than the weighted benchmark step distance. The detecting upper bound step distances may include for each upper bound parameter value in the set of upper bound parameter values and beginning with the smallest upper bound parameter value, calculating an upper bound step distance between the each upper bound parameter value and a next larger upper bound parameter value. The detecting upper bound step distances may further include the removal of semiconductor products that have a parameter value equal to or greater than the next smaller upper bound parameter value from the specification passing set of semiconductor products if the upper bound step distance may be greater than the weighted benchmark step distance. The calculation of the benchmark step distance may include a first set of benchmark step distance calculation steps. The first set of benchmark step distance calculation steps may include calculating a bulk distribution range distance. The bulk distribution range distance may be the lower percentile parameter value subtracted from the upper percentile parameter value. The first set of benchmark step distance calculation steps may further include the calculation of a bulk distribution population size. The bulk distribution population size may be a size of the specification passing set of semiconductor products multiplied by a difference of the lower percentile subtracted from an upper percentile. The benchmark step distance in the first set of benchmark step distance calculation steps may be the bulk distribution range distance divided by the bulk distribution population size. The calculation of the benchmark step distance may include a second set of benchmark step distance calculation steps. The second set of benchmark step distance calculation steps may include the calculation of a bulk distribution set of parameter values. The bulk distribution set of parameter values may include parameter values from the specification passing set that may be in a range between an upper percentile parameter value and the lower percentile parameter value. The second set of benchmark step distance calculation steps may further include the calculation of a set of bulk distribution distances. The set of bulk distribution distances may include distances between each parameter value in the set of bulk distribution distances and an adjacent parameter value also in the set of bulk distribution distances. The benchmark step distance in the first set of benchmark step distance calculation steps may be a largest step distance in the set of bulk distribution step distances.

In accordance with yet another aspect of the present invention, a method of screening quality risk semiconductor products is provided. This method includes the following steps described in this paragraph. The order of the steps may vary, may be sequential, may overlap, may be in parallel, and combinations thereof, if not otherwise stated. A parameter is tested in a plurality of semiconductor products. A specification passing set of semiconductor products is formed from semiconductor products in the plurality of semiconductor products. The semiconductor products in the specification passing set of semiconductor products have a parameter value of the parameter within a specification range. An upper percentile parameter value is calculated in the specification passing set of parameter values. The upper percentile parameter value is at an upper percentile of the specification passing set of parameter values. A benchmark step distance is calculated. An upper bound of the specification passing set of parameter values is screened. The screening of the upper bound of the specification passing set of parameter values includes the formation of a set of upper bound parameter values. The parameter values in the set of upper bound parameter values are at and above the upper percentile parameter value. The screening of the upper bound of the specification passing set of parameter values further includes sorting the set of upper bound parameter values from a smallest upper bound parameter value to a largest upper bound parameter value. The screening of the upper bound of the specification passing set of parameter values still further includes detecting upper bound step distances that are greater than the weighted benchmark step distance. The detecting upper bound step distances includes for each upper bound parameter value in the set of upper bound parameter values and beginning with the smallest upper bound parameter value, calculating an upper bound step distance between the each upper bound parameter value and a next larger upper bound parameter value. The detecting upper bound step distances further includes the removal of semiconductor products that have a parameter value equal to or greater than the next smaller upper bound parameter value from the specification passing set of semiconductor products if the upper bound step distance is greater than the weighted benchmark step distance.

This paragraph describes some embodiments of the aspect of the present invention described in the immediately preceding paragraph. The benchmark step distance may be a weighted benchmark step distance, and the weighted benchmark step distance may be the benchmark step distance multiplied by a step weighting number. A lower bound of the specification passing set of parameter values may be screened. The screening of the lower bound of the specification passing set of parameter values may include the formation of a set of lower bound parameter values. The parameter values in the set of lower bound parameter values may be at and below the lower percentile. The screening of the lower bound of the specification passing set of parameter values may further include sorting the set of lower bound parameter values from a largest lower bound parameter value to a smallest lower bound parameter value. The screening of the lower bound of the specification passing set of parameter values may still further include detecting lower bound step distances that may be greater than the weighted benchmark step distance. The detecting lower bound step distances may include for each lower bound parameter value in the set of lower bound parameter values and beginning with the largest lower bound parameter value, calculating a lower bound step distance between the each lower bound parameter value and a next smaller lower bound parameter value. The detecting lower bound step distances may further include the removal of semiconductor products that have a parameter value equal to or less than the next smaller lower bound parameter value from the specification passing set of semiconductor products if the lower bound step distance may be greater than the weighted benchmark step distance. The calculation of the benchmark step distance may include a first set of benchmark step distance calculation steps. The first set of benchmark step distance calculation steps may include calculating a bulk distribution range distance. The bulk distribution range distance may be the lower percentile parameter value subtracted from the upper percentile parameter value. The first set of benchmark step distance calculation steps may further include the calculation of a bulk distribution population size. The bulk distribution population size may be a size of the specification passing set of semiconductor products multiplied by a difference of the lower percentile subtracted from an upper percentile. The benchmark step distance in the first set of benchmark step distance calculation steps may be the bulk distribution range distance divided by the bulk distribution population size. The calculation of the benchmark step distance may include a second set of benchmark step distance calculation steps. The second set of benchmark step distance calculation steps may include the calculation of a bulk distribution set of parameter values. The bulk distribution set of parameter values may include parameter values from the specification passing set that may be in a range between an upper percentile parameter value and the lower percentile parameter value. The second set of benchmark step distance calculation steps may further include the calculation of a set of bulk distribution distances. The set of bulk distribution distances may include distances between each parameter value in the set of bulk distribution distances and an adjacent parameter value also in the set of bulk distribution distances. The benchmark step distance in the first set of benchmark step distance calculation steps may be a largest step distance in the set of bulk distribution step distances.

The foregoing has outlined rather broadly features of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a flowchart showing steps in a first illustrative embodiment of the present invention;

FIG. 2 is a plot of the distribution of test measurements in the first illustrative embodiment of the present invention;

FIGS. 3-6 are flowcharts showing steps in the first illustrative embodiment of the present invention;

FIG. 7 is a flowchart showing steps in a second illustrative embodiment of the present invention;

FIG. 8 is a plot of the distribution of test measurements in a third illustrative embodiment of the present invention;

FIG. 9 is a flowchart showing steps in the third illustrative embodiment of the present invention;

FIG. 10 is a plot of the distribution of test measurements in a fourth illustrative embodiment of the present invention; and

FIG. 11 is a flowchart showing steps in the fourth illustrative embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

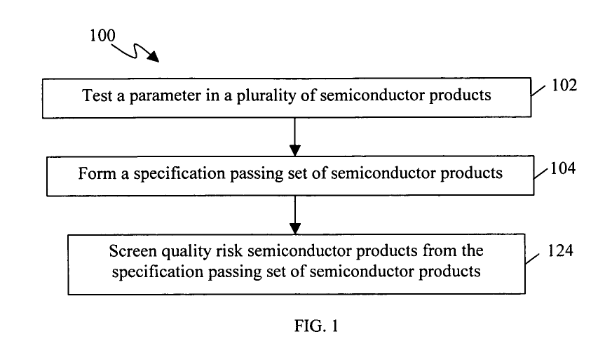

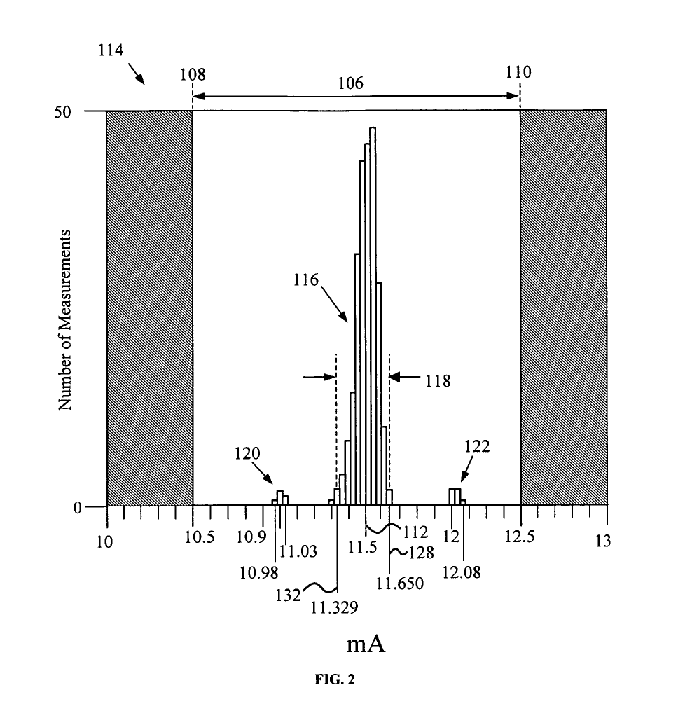

Generally, an embodiment of the present invention provides a method of the present invention. FIGS. 1-6 illustrate the first illustrative embodiment, which provides a method of forming a quality passing set of semiconductor products. FIGS. 1 and 3-6 are flowchart diagrams illustrating steps in the first embodiment. FIG. 2 is a plot of example test measurements in the first embodiment.

With reference now to FIG. 1, steps in the method of the first embodiment 100 are shown. In step 102 of FIG. 1, a parameter is tested in a plurality of semiconductor products. The plurality of semiconductor products in the first illustrative embodiment is 221 packaged semiconductor chips (not shown) intended for use in automotive electronic parts, for example. The packaged semiconductor chips include die that have been selected from a number of wafers. The wafers are from a plurality of processed wafer lots. The die have been packaged in a packaging material and electrically conductive leads have been routed from the bond pads on the die to the outside of the packaging material.

In other embodiments, the plurality of semiconductor products may be any number of semiconductor components, elements, entities, or materials, at any stage of the semiconductor manufacturing, packaging, or testing process. In one embodiment of the present invention, 50 semiconductor wafers may be tested for a layer thickness after a material deposition process (e.g., plasma enhanced chemical vapor deposition, or oxide deposition). In another illustrative embodiment of the present invention, the amount of output current in each of 201 die in a semiconductor wafer is tested. In yet another embodiment of the present invention an output voltage is tested in 250 wafers prior to a wafer sort step. In still yet another embodiment of the present invention, the power dissipation of each of 10,000 NPN transistor components are tested.

The parameter of the first embodiment in step 102 of FIG. 1 is output current expressed in milliamps (mA), for example. Parameters in other illustrative embodiments may include current and power characteristics, for example. Additional examples of parameters include: on resistance, source leakage current, drain leakage current, logic input high voltage (VIH), logic input low voltage (VIL), logic output high voltage (VOH), logic output low voltage (VOL), logic input current high (IIH), logic input current low (IIL), turn on time, turn off time, read cycle time, address access time, chip select access time, write cycle time, common mode rejection (CMR), and power supply rejection (PSR), for example.

The test in step 102 of FIG. 1 in the first embodiment is a final test. Final test or final electrical test is known by one skilled in the art to include one or more tests performed on the 221 packaged semiconductor chips before releasing the chips for customer delivery or shipping, for example. For the final test of the first embodiment, each of the 221 packaged semiconductor chips are electrically stimulated and an output current is measured.

In step 104 of the first embodiment shown in FIG. 1, the output current measurements of each of the 221 packaged semiconductor chips are compared to a preselected output current specification range of desired output current levels. The output current specification range referred to in step 104 of FIG. 1 is shown in FIG. 2.

In FIG. 2, the output current specification range 106 of the first embodiment 106 has been preselected to provide a level of quality control that is acceptable to a broad range of users of the packaged semiconductor chips. The output current specification range 106 of the first embodiment has a lower specification limit 108 of 10.5 mA and an upper specification limit 110 of 12.5 mA. The output current specification range 106 is centered about the desired output current 112 of 11.5 mA.

Combined reference shall now be made to step 104 of the first embodiment in FIG. 1 and the frequency distribution of test measurements for the first embodiment shown in FIG. 2. Semiconductor chips of the first embodiment that have output current measurements inside the output current specification range 106 (see FIG. 2) form a specification passing set of packaged semiconductor chips 104 (see FIG. 1). In step 104 of FIG. 1, 201 of the 221 packaged semiconductor chips are determined to have an output current measurement inside the specification range, thus passing the output current parameter test. The 20 packaged semiconductor chips that fail the output current parameter test are removed from the set of 221 packaged semiconductor chips. The remaining 201 packaged semiconductor chips form the specification passing set of step 104 (see FIG. 1).

With reference to FIG. 2, the packaged semiconductor chips of the first illustrative embodiment are intended for use in automotive electronic parts. To be used in automotive electronic parts, the packaged semiconductor chips in the specification passing set of the first embodiment are expected to meet the level of quality control required for automotive electronic parts, in addition to being within the specification range 106. In the first embodiment, automotive electronic part quality control requires that in addition to being within the specification range, the packaged semiconductor chips must have an output current measurement that does not significantly deviate from the desired target output current measurement of 11.5 mA. The desired target output current measurement 112 is shown in FIG. 2. The semiconductor chips in the specification passing set of packaged semiconductor products that have an output current measurement that is within an acceptable range of the target output current measurement 112 will be included in a quality passing set of packaged semiconductor chips. The semiconductor chips in the quality passing set will be available for use in electronic automotive parts.

In FIG. 2, the frequency distribution 114 of the output current measurements for the 201 packaged semiconductor chips in the specification passing set of the first embodiment is shown. The distribution 114 includes a bulk distribution 116 of output current measurements in a bulk distribution range 118. The bulk distribution range 118 is generally centered about the desired output current 112 of 11.5 mA. The distribution 114 also includes smaller outlying distributions below 120 and above 122 the bulk distribution 116.

Referring now to FIG. 1, following the formation of the specification passing set of semiconductor chips 104, quality risk semiconductor chips are screened from the specification passing set to form a quality passing set of semiconductor products 124.

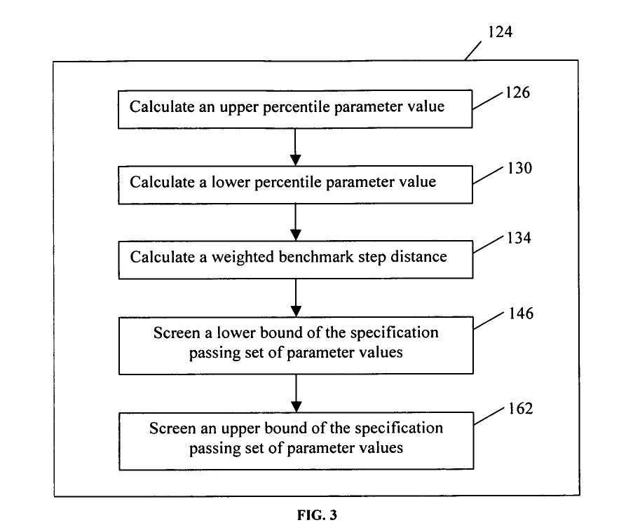

With combined reference to FIGS. 1-3, the calculation of an upper percentile output current measurement 126 in the first embodiment is described. The step 124 in FIG. 1 includes the steps shown in FIG. 3. With reference to FIG. 3, steps used to screen quality risk semiconductor chips from the specification passing set 124 are illustrated. A first step in the screening 124 (see FIG. 3) of quality risk packaged semiconductor chips from the specification set of the first embodiment is the calculation of an upper percentile output current measurement 126 (see FIG. 3). The upper percentile of the first illustrative embodiment is 97%. The upper percentile output current measurement is the output current measurement that is ranked at a 97^{th} percentile of the 201 output current measurements in the specification passing set. In the first embodiment, the 97^{th} largest output current measurement in the specification passing set of packaged semiconductor chips is 11.650 mA. FIG. 2 shows the upper percentile output current measurement 128.

With combined reference to FIGS. 2 and 3, a lower percentile output current measurement is calculated in step 130 of FIG. 3. The lower percentile in the first illustrative embodiment is 3%. The lower percentile output current measurement is the output current measurement that is ranked at a 3^{rd} percentile of the 201 output current measurements in the specification passing set. The lower percentile output current measurement ranked at the 3rd percentile in the first illustrative embodiment is 11.329 mA. The lower percentile output current measurement 132 of the first embodiment is shown in FIG. 2.

In FIG. 3, Although step 126 and step 130 are performed in sequence in the first embodiment, the steps may be performed in parallel, or in overlapping order, for example. Furthermore, in embodiments of the present invention the calculation of the lower percentile parameter value 130 may be performed before the calculation of the upper percentile parameter value 126, for example.

The lower percentile and the upper percentile may be any percentage numbers. Although the lower percentile and the upper percentile in the first embodiment are symmetrically distanced from 50% (e.g., 3% is a distance of 47% from 50% and 97% is a distance of 47% from 50%), in other embodiments the lower percentile and the upper percentile may be asymmetrically distanced from the 50th percentile. For example, in another embodiment of the present invention the lower percentile may be 0% and the upper percentile may be 93%. In another embodiment, the lower percentile may be 15% and the upper percentile may be 100%, for example.

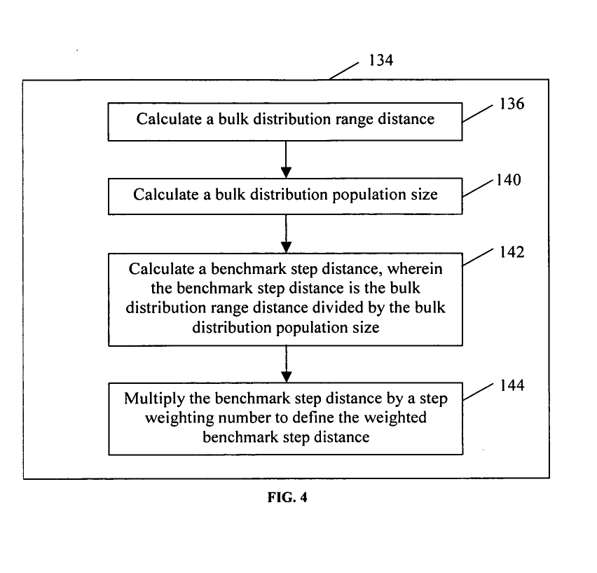

With reference to FIG. 3, the screening of quality risk semiconductor products 124 still further includes calculating a weighted benchmark step distance 134. The calculation of the weighted benchmark step distance 134 in FIG. 3 includes the steps shown in FIG. 4, in accordance with the first embodiment.

Combined reference will now be made to the distribution of test measurements 114 in FIG. 2 and to the steps for calculating a weighted benchmark step distance 134 in FIG. 4. Referring now to FIG. 4, a first step in the calculation of the weighted benchmark step distance 134 is to calculate a bulk distribution range distance 136. In FIG. 2, the bulk distribution range distance 118 is the distance between the upper percentile output current measurement 128 at 11.650 mA and the lower percentile output current measurement 132 at 11.329 mA. The bulk distribution range distance 118 in the first illustrative embodiment is 0.321 mA.

With reference now to FIG. 4, the calculation of the weighted benchmark step distance 134 further includes calculating a bulk distribution population size 140. The bulk distribution population size is calculated in the first embodiment by multiplying the size of the specification passing set of semiconductor products (e.g., 201 packaged semiconductor chips) by a difference of the lower percentile of 3% subtracted from the upper percentile of 97%. The bulk distribution population size is 189, which is 94% of 201.

As shown in step 142 of FIG. 4, the calculation of the weighted benchmark step distance 134 still further includes calculating a benchmark step distance 142. The benchmark step distance is the bulk distribution range distance of 0.321 mA divided by the bulk distribution population size of 189. The benchmark step distance of the first embodiment is therefore 1.698 microamps (μA).

As shown in step 144 of FIG. 4, the weighted benchmark step distance is scaled by multiplying the benchmark step distance by a step weighting number. In the first illustrative embodiment, the step weighting number is 0.925. Thus, the weighted benchmark step distance in the first embodiment is the product of the step weighting number of 0.925 and the benchmark step distance of 1.698 μA, the result being 1.571 μA. The step weighting number may be any number including 0, 10⁻³, 0.856, 1.0, 1.3, 50, and 10³, for example.

The scaling 144 of the benchmark step distance by the step weighting number in the first illustrative embodiment advantageously provides control in the screening of quality risk packaged semiconductor chips. The numerical properties and characteristics (e.g., mean, median, sigma, population size, standard deviation) of a semiconductor process or a specific product in a semiconductor process may vary, and it may be highly desirable to scale the benchmark step distance with a step weighting number in order to compensate for these variations, for example.

The benchmark step distance in the first embodiment may also be referred to as an average benchmark step distance. The average benchmark step distance in embodiments of the present invention may be calculated using any averaging method. For example, the average benchmark step distance in other embodiments may be the median step distance of the set of step distances in the bulk distribution range. In another embodiment, the average step distance may be calculated by selecting a step distance that is at a percentile (e.g., 45%, 55%, or 65%) of the set of step distances in the bulk distribution range. In yet another embodiment, the average step distance may be calculated by averaging the sum of one or more percentile step distances that are near the 50^{th} percentile or symmetrically distanced from the 50^{th} percentile. For example, an average benchmark step distance in an embodiment may be the sum of the 40^{th} percentile step distance in the bulk distribution range and the 60^{th} percentile step distance in the bulk distribution range divided by 2.

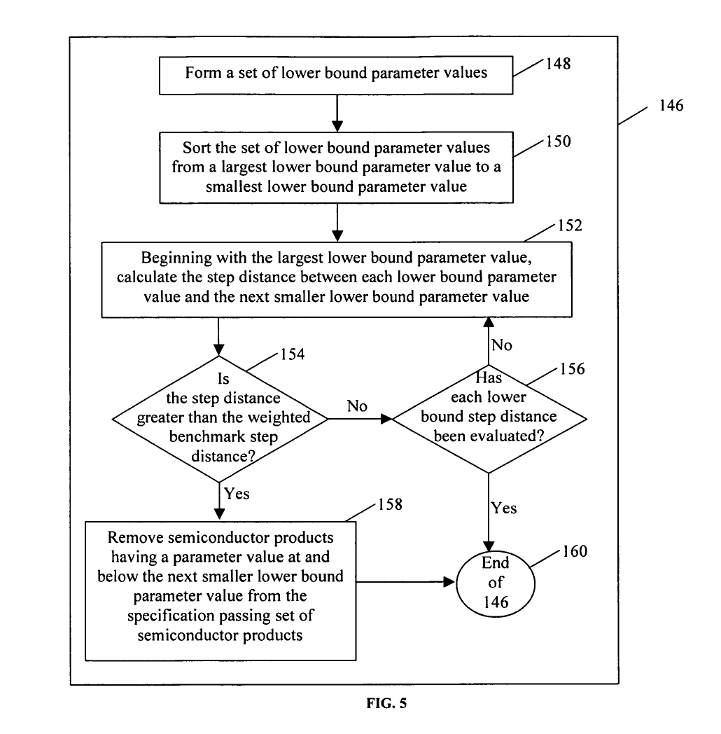

Returning now to the steps in FIG. 3 for screening quality risk semiconductor chips 124, a lower bound of the specification passing set of output current measurements is screened 146. Steps in the screening of the lower bound of the specification passing set of output current measurements 146 are shown in FIG. 5.

With combined reference to FIG. 5 and Table 1 (below), results of steps 148-158 in FIG. 5 are shown in Table 1. In FIG. 5, the screening of the lower bound of the specification passing set 146 loops through steps 152-156 in FIG. 5. The rows 1-3 in Table 1 show calculated results for several iterations of the loop formed by steps 152-156 in FIG. 5. The rows 4-7 in Table 1 illustrate the result of step 158 in FIG. 5.

TABLE 1

| | Column | | | | |
|---|---|---|---|---|---|
| | | 2 | 3 | 5 | |
| | 1 | Lower Bound | Step Distance | Lower Bound Step | 6 |
| | Percentile | Output Current | To The Next | Distance Greater Than | Removed from |
| | Rank | Measurement | Smaller | Weighted Benchmark | Specification |
| Row | (%) | (mA) | Measurement (μA) | Step Distance? | Passing Set? |
| 1 | 3.0 | 11.329 | 1.0 | No | No |
| 2 | 2.5 | 11.328 | 1.0 | No | No |
| 3 | 2.0 | 11.327 | 297.0 | Yes | No |
| 4 | 1.5 | 11.030 | | | Yes |
| 5 | 1.0 | 11.000 | | | Yes |
| 6 | 0.5 | 10.985 | | | Yes |
| 7 | 0.0 | 10.980 | | | Yes |

In FIG. 5, the screening of the lower bound of the specification passing set of output current measurements 146 includes forming a set of lower bound output current measurements 148. In Table 1, the set of lower bound output current measurements is shown in column 2. The set of lower bound output current measurements in column 2 includes output current measurements from the specification passing set that are equal to or less than the lower percentile output current measurement of 11.329 mA.

Steps in the screening of the lower bound 146 shown in FIG. 5 further include sorting the lower bound output current measurements 150. As shown in Table 1, the lower bound output measurements in column 2 are sorted from a largest measurement of 11.329 mA (e.g., the 3^{rd} percentile) in row 1 to a smallest lower bound output current measurement of 10.980 mA in row 7.

The results of a first loop iteration formed by steps 152-156 in FIG. 5 are shown in row 1 of Table 1. With reference to step 152 in FIG. 5, the lower bound step distance between the largest lower bound measurement of 11.329 mA (see e.g., row 1, col. 2 in Table 1) and the next smaller lower bound measurement of 11.328 mA (see e.g., row 2, col. 2 in Table 1) is calculated to be 1 μA (see e.g., row 1, col. 3 in Table 1).

In decision step 154 of FIG. 5, the step distance of 1 μA is compared to the weighted benchmark step distance of 1.571 μA. The result of step 154 in FIG. 5 is shown in row 1, column 5 of Table 1. Because the step distance of 1 μA is not greater than the weighted benchmark step distance of 1.571 μA, the result of the decision step 154 is No (a.k.a., false or negative), and step 156 becomes the next step. Because lower bound output measurements still remain to be calculated (e.g., the distances in column 3, rows 2-6 of Table 1), the result of decision step 156 in FIG. 5 is No and the next step becomes step 152. This ends the first iteration of the loop formed by steps 152-156.

The results of a second loop iteration formed by steps 152-156 in FIG. 5 are shown in row 2 of Table 1. Step 152 in FIG. 5 is performed a second time, and the step distance between the lower bound output current measurement of 11.328 mA (see e.g., row 2, col. 2 in Table 1) and the next smaller output current measurement of 11.327 mA (see e.g., row 3, col. 2 in Table 1) is calculated to be 1 μA (see e.g., row 2, col. 3 in Table 1). Because the step distance of 1 μA in the second loop iteration is not greater than the weighted benchmark step distance of 1.571 μA, the decision step 154 is followed by step 156. Because lower bound step distances remain to be calculated (e.g., the distances in column 3, rows 3-6 of Table 1), the result to the decision step 156 is No, and the next step becomes step 152. This ends the second iteration of the loop formed by steps 152-156.

In a third iteration of the loop formed by steps 152-156, step 152 in FIG. 5 is performed a third time. The result of calculating a third lower bound distance between the lower bound output current measurement of 11.327 mA (see e.g., row 3, col. 2 in Table 1) and the next smaller output current measurement of 11.030 mA (see e.g., row 4, col. 2 in Table 1) is 297 μA (see e.g., row 3, col. 3 in Table 1). In the next step 154 of FIG. 5, the lower bound step distance of 297 μA is determined to be greater than the weighted benchmark step distance of 1.571 μA. The Yes (a.k.a. True, positive) result to the decision step 154 leads to step 158.

In the third iteration of the loop formed by steps 152-156, the next smaller lower bound measurement is the 1.5 percentile measurement of 11.030 mA in row 4, column 2. Thus, in step 158 of FIG. 5, the next smaller lower bound output current measurement is 11.030 mA. Any packaged semiconductor chips in the specification passing set that have an output current measurement of 11.030 mA or less are removed from the specification passing set. Column 6 of Table 1 identifies the packaged semiconductor chips in rows 4-7 that are removed from the specification passing set. In step 158 of the first embodiment, a total of 4 packaged semiconductor chips are removed from the specification passing set of 201 chips, leaving 197 chips in the specification passing set.

In FIG. 5, upon completion of step 158, step 146 is complete (see block 160 in FIG. 5). Block 160 represents the end of step 146. Thus, block 160 is the end of the screening of the lower bound of the specification passing set of packaged semiconductors in the first embodiment. The method of the first embodiment 100 (see FIG. 1) returns to the screening of quality risk products from the specification passing set 124 shown in FIG. 3.

In other embodiments of the present invention, all step distances in the lower bound may be smaller than the weighted benchmark step distance. In these embodiments, step 158 in FIG. 5 is not executed. Rather, in a final iteration of the loop formed by steps 152-156, the result of step 156 is positive, which leads to the completion of step 146 (block 160).

With reference to FIG. 3, the next step performed in the screening of quality risk products from the specification passing set 124 is the screening of an upper bound of the specification passing set of measurements 162. Although step 146 and 162 are performed in sequence in the first embodiment, the steps may be performed in parallel, or in overlapping order, for example. Furthermore, in embodiments of the present invention the screening of the upper bound 162 may be performed before the screening of the lower bound of the specification passing set 142, for example.

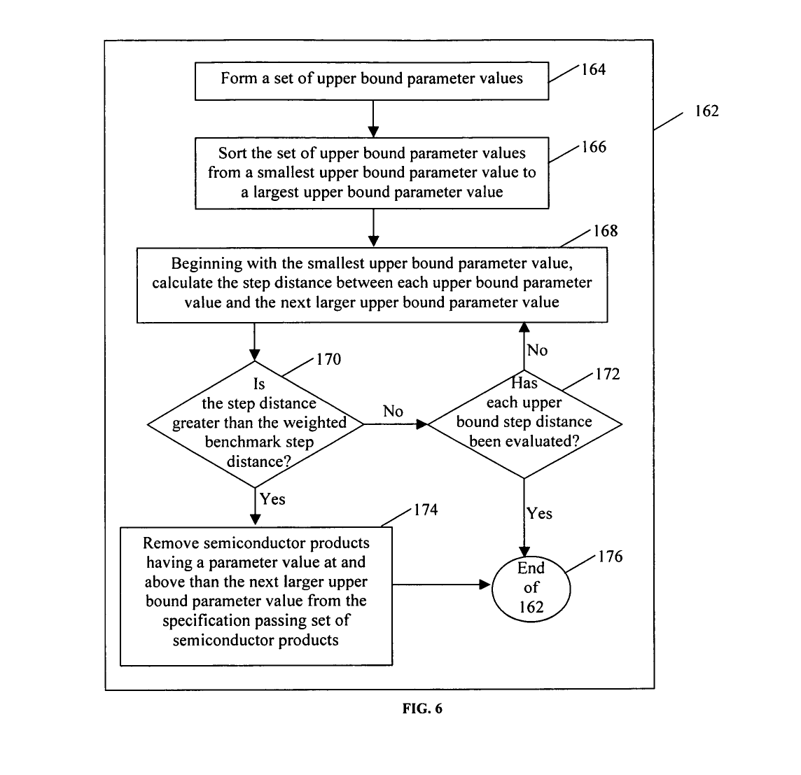

The steps performed in the screening of the upper bound of the specification passing set 162 are shown in FIG. 6. With combined reference to FIG. 6 and Table 2 (below), results of the steps 164-174 shown in FIG. 6 are shown in Table 2. In FIG. 6, the screening of the upper bound of the specification passing set 162 loops through steps 168-172. The rows 1 and 2 in Table 2 show calculated results for several iterations of the loop formed by steps 168-172 in FIG. 6. Rows 3-7 in Table 2 illustrate the result of step 174 in FIG. 6.

TABLE 2

| | column | | | | |
|---|---|---|---|---|---|
| | | 2 | 3 | | |
| | 1 | Upper Bound | Upper | 5 | 6 |
| | Percentile | Output Current | Bound Step | Upper Bound Step Distance | Removed from |
| | Rank | Measurement | Distance | Greater Than Weighted | Specification |
| row | (%) | (mA) | (μA) | Benchmark Step Distance? | Passing Set? |
| 1 | 97.0 | 11.650 | 0 | No | No |
| 2 | 97.5 | 11.650 | 350.0 | Yes | No |
| 3 | 98.0 | 12.000 | | | Yes |
| 4 | 98.5 | 12.000 | | | Yes |
| 5 | 99.0 | 12.040 | | | Yes |
| 6 | 99.5 | 12.041 | | | Yes |
| 7 | 100.0 | 12.080 | | | Yes |

In FIG. 6, the screening of the upper bound of the specification passing set of output current measurements 162 includes forming a set of upper bound output current measurements 164. In Table 2, the set of upper bound output current measurements is shown in column 2. The set of upper bound output current measurements in column 2 includes output current measurements from the specification passing set that are equal to or greater than the upper percentile output current measurement of 11.650 mA.

Steps in the screening of the upper bound 162 shown in FIG. 6 further include sorting the upper bound output current measurements 166. As shown in Table 2, the upper bound output measurements in column 2 are sorted from a smallest measurement of 11.650 mA (e.g., the 97th percentile) in row 1 to a largest upper bound output current measurement of 12.080 mA in row 7.

The results of a first loop iteration formed by steps 168-172 in FIG. 6 are shown in row 1 of Table 2. With reference to step 168 in FIG. 6, the upper bound step distance between the largest upper bound measurement of 11.650 mA (see e.g., row 1, col. 2 in Table 2) and the next larger upper bound measurement of 11.650 mA (see e.g., row 2, col. 2 in Table 2) is calculated to be 0 μA (see e.g., row 1, col. 3 in Table 2).

With reference to the decision step 170 in FIG. 6, the upper bound step distance of 0 μA is compared to the weighted benchmark step distance of 1.571 μA. The no result of the comparison in step 170 of FIG. 6 is shown in Table 2, row 1, column 5. Referring to FIG. 6, because the step distance of 0 μA is not greater than the weighted benchmark step distance of 1.571 μA, the negative result to the decision step 170 leads to step 172.

In the decision step 172 of FIG. 6, upper bound output distances remain (e.g., distances in column 3, rows 2-6 of Table 2) to be calculated. Thus, the result to the decision step 172 is No, which leads back to step 168. This ends the first iteration of the loop formed by steps 168-172.

In a second iteration of the loop formed by steps 168-172, step 168 in FIG. 6 is performed a second time. The result of calculating a second upper bound distance between the upper bound output current measurement of 11.650 mA (see e.g., the 97.5 percentile measurement in row 2, col. 2 in Table 2) and the next larger output current measurement of 12.000 mA (see e.g., row 3, col. 2 in Table 2) is 350 μA (see e.g., row 2, col. 3 in Table 2). The next step in the second loop iteration is step 170 of FIG. 6, in which the upper bound step distance of 350 μA is determined to be greater than the weighted benchmark step distance of 1.571 μA. Therefore, the following step in the screening of the upper bound for quality risk products 162 is step 174.

In the second iteration of the loop formed by steps 168-172, the next larger upper bound measurement is 12.000 mA (see e.g., row 3, col. 2 in Table 2). In step 174 of FIG. 6, the next larger upper bound output current measurement is therefore also 12.000 mA. In Table 2, column 6, rows 3-7, the test measurements of packaged semiconductor chips that have an output current measurement of 12.000 mA or greater and which are removed from the specification passing set are identified.

After step 174 in FIG. 6 is performed, step 162 is complete (block 176 in FIG. 6). Block 176 represents the end of the screening of the upper bound 162. In other embodiments of the present invention, all step distances in the upper bound may be less than the weighted benchmark step distance. In these embodiments, step 174 in FIG. 5 is not executed. Rather, in a final iteration of the loop formed by steps 168-172, the result of step 172 is Yes, which leads to block 176 as shown in FIG. 6.

With combined reference to FIGS. 1, 3, and 6, it is shown that step 162 is the last step in the first embodiment. In FIG. 6, step 172 is the last step of the screening of the upper bound 162. In FIG. 3, the screening of the upper bound of the specification passing set 162 is the last step in the screening of quality risk products from the specification passing set 124. In FIG. 1, the screening of quality risk products 124 is the last step in the method of the first embodiment 100.

In the first embodiment, a total of 9 packaged semiconductor chips are screened from the 201 packaged semiconductor chips in the specification passing set. Four packaged semiconductor chips are screened from the lower bound of the specification passing set and 5 semiconductor chips are screened from the upper bound of the specification passing set. The 192 packaged semiconductor chips that pass the upper bound screening 164 and lower bound screening 146 form a quality passing set of packaged semiconductor chips that meet the quality control requirements for automotive electronic parts in this example.

An advantage of embodiments of the present invention is that semiconductor products that have test measurements in a specification range but which lie outside quality control boundaries are not rejected, thus raising yield and generating additional revenue. In prior art methods, all chips outside a predetermined set of quality control boundaries may be rejected. In one example of a known quality control method performed on 201 semiconductor products, all products outside the 3^{rd} and 97^{th} percentile may be rejected, resulting in the rejection of 12 products. In the first embodiment however, 5 of the 201 packaged semiconductor chips outside the 3^{rd} and 9^{th} percentile quality control boundaries were included in the quality passing set. In the first embodiment, 9 of the 201 chips in the specification passing set were rejected. Thus 3 chips that might have been rejected in prior art methods were determined to meet quality requirements in the first embodiment of the present invention. The preservation of quality passing semiconductor products that have tested measurements outside quality control boundaries, such as the quality control boundaries at the 3rd and 97th percentiles in the first embodiment, may raise yield and may be used to generate additional revenue. For example, each of the 3 chips in the first embodiment may be sold for $100.00, thus generating an additional $300.00.

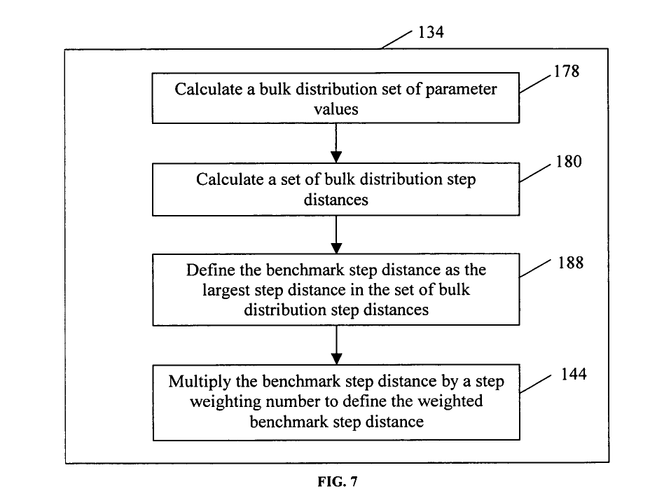

In a second embodiment of the present invention, the calculation of a weighted benchmark step distance (e.g., step 134 in FIG. 3) is performed as shown in FIG. 7. With reference now to FIG. 7, the calculation of the weighted benchmark step distance 134 includes calculating a bulk distribution set of output current measurements 178. The bulk distribution set of output current measurements includes output current measurements from the specification passing set of measurements between and including the 3^{rd} percentile and the 97^{th} percentile.

Table 3 generally illustrates the results of the calculations for forming the bulk distribution set of output current measurements 178. For illustrative purposes, Table 3 does not include a full listing of the output current measurements in the bulk distribution set of the second embodiment. Rather, Table 3 shows the output current measurements in the bulk distribution that are near the 3^{rd} percentile and near the 97^{th} percentile. Bulk distribution output current measurements that are between the 3^{rd} percentile and the 97^{th} percentile but which are not shown are represented with ellipsis (i.e., “ . . . ”).

TABLE 3

| | Bulk Distribution | Distance |
|---|---|---|
| | Output Current | To Adjacent |
| | Measurements | Measurement |
| Percentile Rank | (mA) | (μA) |
| 3.0 | 11.329 | 1.0 |
| 3.5 | 11.330 | 1.0 |
| 4.0 | 11.331 | 1.0 |
| . . . | . . . | . . . |
| 96.0 | 12.620 | 20.0 |
| 96.5 | 12.640 | 0.0 |
| 97.0 | 12.650 | n/a |

A set of bulk distribution step distances is calculated 180. The set of bulk distribution step distances includes distances between each output current measurement in the set of bulk distribution output current measurements (see e.g., the middle of column 3) and an adjacent output current measurement also in the set of bulk distribution output current measurements.

The right-most column of Table 3 shows the bulk distribution step distances for the measurements in the bulk distribution set of output current measurements. Each adjacent distance in Table 3 is the distance between a bulk distribution output current measurement and a next larger bulk distribution output current measurement. For example, the distance between the measurement 11.330 mA and the next larger measurement of 11.331 mA is 1.0 μA.

With combined reference to step 188 of FIG. 7 and Table 3, the largest step distance in the bulk distribution of step distances is the distance of 20 μA between the output current measurement 12.620 mA (e.g., the 96^{th} percentile in Table 3) and 12.640 mA (e.g., the 96.5 percentile in Table 3). The largest bulk distribution step distance in the second embodiment may also be referred to as the maximum bulk distribution step distance.

Step 144 of the second embodiment shown in FIG. 7 is performed the same as step 144 of the first embodiment. In accordance with the second embodiment and as shown in step 144 of FIG. 7, the calculation of the weighted benchmark step distance yet further includes multiplying the 20 μA by a step weighting number to define the weighted benchmark step distance. The step weighting number in the second embodiment is 0.95. Thus, the weighted benchmark step distance of the second illustrative embodiment is 19 μA.

An advantage provided by embodiments of the present invention is control of the weighted benchmark step distance. In embodiments of the present invention, multiple methods are provided to calculate a weighted benchmark step distance. For example, the method of calculating the weighted benchmark step distance in the first embodiment (see e.g., steps 136, 140-144 in FIG. 4) provides an average weighted benchmark step distance. The method of calculating the weighted benchmark step distance in the second embodiment (see e.g., steps 178, 180, 188, 144 in FIG. 7) provides a maximum weighted benchmark step distance. The multiple methods of calculating the weighted benchmark step distance provided by embodiments of the present invention advantageously grants a user the control to vary benchmark step distance if desired.

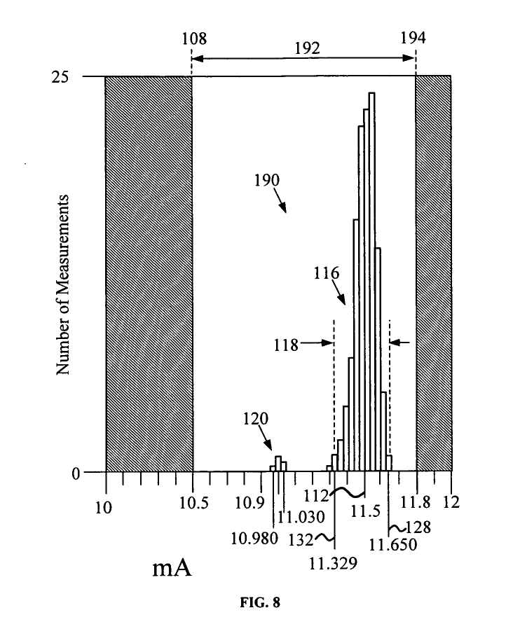

Steps in the third embodiment of the present invention are performed in the same manner as steps 130, 134, and 146 of the first embodiment shown in FIGS. 3-5. The distribution of test measurements for a third embodiment is graphically illustrated in FIG. 8. FIG. 8 plots the distribution 190 of 101 output current measurements in a specification passing set of output current measurements. The 101 output current measurements of the third embodiment are in a specification range 192 between a lower specification level (LSL) 108 of 10.5 mA and an upper specification level (USL) 194 of 11.8 mA.

The distribution 190 of the output current measurements for the 101 packaged semiconductor chips in the specification passing set of the third embodiment includes a bulk distribution 116 of output current measurements in a bulk distribution range 118. The bulk distribution range 118 is generally centered about the desired output current 112 of 11.5 mA. The distribution 190 also includes a smaller outlying group of measurements 120 below the bulk distribution 116 of measurements.

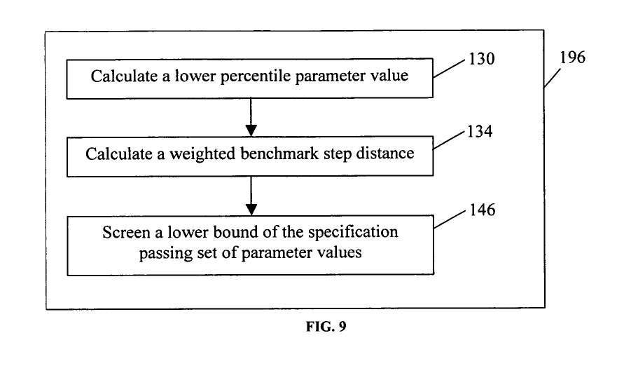

The steps of the third embodiment 196 are shown in FIG. 9. A first step in the third embodiment 196 is the calculation of a lower percentile measurement 130. Step 130 of the third embodiment 196 is the same as the calculation of the lower percentile measurement in the first embodiment 100 shown in step 130 of FIG. 3. The lower percentile in the third embodiment 196 is the 3rd percentile, and as shown in Table 4 below, the lower bound output current measurement at the 3rd percentile of the specification passing set in the third embodiment is 11.329 mA.

TABLE 4

| | Lower Bound | | Lower Bound Step | |
|---|---|---|---|---|
| | Output Current | Distance | Distance Greater Than | Removed from |
| Percentile | Measurement | To Next Smaller | Weighted Benchmark | Specification Passing |
| Rank (%) | (mA) | Measurement (μA) | Step Distance? | Set? |
| 3.0 | 11.329 | 2.0 | No | No |
| 2.0 | 11.327 | 327.0 | Yes | No |
| 1.0 | 11.000 | | | Yes |
| 0.0 | 10.980 | | | Yes |

The upper percentile of the third embodiment of the present invention is 100%. FIG. 8 shows the 100th percentile output current measurement 128 of 11.650 mA in the distribution 190.

With reference to FIG. 9, the next step in the third embodiment is the calculation of a weighted benchmark step distance 134. Step 134 of the third embodiment 196 may be the same as the calculation of a weighted benchmark step distance 134 in the first embodiment shown in FIG. 4 (or may be the same as step 134 in other embodiments). Referring now to FIG. 4, the benchmark range distance in the third embodiment is calculated 136 by subtracting the 3rd percentile measurement (e.g., 11.329 mA) from the 100th percentile measurement in the specification passing set (e.g., 11.625 mA). The resulting benchmark range distance of the third embodiment is 296 μA.

In FIG. 4, the bulk distribution population size of the third embodiment is calculated 140 by subtracting the number of measurements below the 3^{rd} percentile (e.g., 3) and above the 100^{th} percentile (e.g., 0) from the number of measurements in the specification passing set (e.g., 101 measurements). Thus, the bulk distribution population size of the third embodiment is 98.

In FIG. 4, the calculation 142 of the benchmark step distance in the third embodiment is performed by dividing the benchmark range distance of 296 μA by the bulk distribution population size of 98. The benchmark step distance in the third embodiment is therefore 3.020 μA. In step 144 of FIG. 4, the benchmark step distance is multiplied by a step weighting number of 1.0 to define a weighted benchmark step distance of 3.020 μA.

It is noted that setting the step weighting number of 1.0 advantageously provides a means of bypassing the scaling step 144, should it be desired to do. By using a step weighting number of 1.0, the weighted benchmark step distance and the benchmark step distance of an embodiment are the same number, which is equivalent to bypassing the scaling step 144. Hence, step 144 may be deleted or optional in other embodiments.

As shown in FIG. 9, the next step in the method of the third embodiment 196 is the screening of a lower bound of the specification passing set of output current measurements 146. Step 146 of the third embodiment 196 is the same as step 146 of the first embodiment, as shown in FIG. 3.

With combined reference to FIG. 5 and Table 4 (above), results of performing the steps in step 146 of the third embodiment are shown in Table 4. The results of the screening of the lower bound of the specification passing set of semiconductor chip output current measurements 146 in the third embodiment are shown in Table 4. In Table 4, it is seen that although the lower bound step distance of 2.0 μA between the 3rd percentile measurement and the 2nd percentile measurement is less than the weighted benchmark step distance of 3.020 μA, the lower bound step distance of 327 μA between the 2nd percentile measurement and the 1st percentile measurement is greater than the weighted benchmark step distance. Thus, semiconductor chips in the third embodiment having an output current measurement of 11.000 mA or smaller are removed from the specification passing set.

In the third embodiment, two packaged semiconductor chips are screened from the lower bound of the specification passing set of packaged semiconductor chips. The 99 remaining packaged semiconductor chips in the specification passing set of packaged semiconductor chips form a quality passing set of packaged semiconductor chips.

One of the advantages provided in the third embodiment is that one of the semiconductor chips below the lower percentile was not rejected and was therefore included in the quality set of semiconductor chips of the third embodiment. The inclusion of this chip having a parameter measurement below the lower percentile may provide a higher yield and increased revenue.

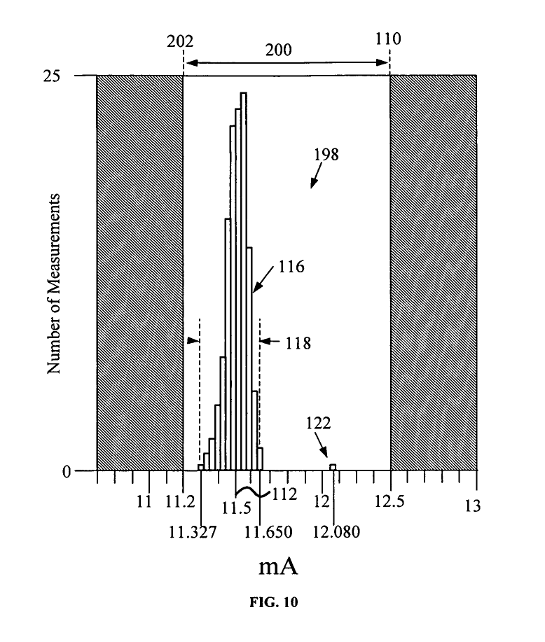

The distribution of test measurements for a fourth embodiment is graphically illustrated in FIG. 10. FIG. 10 plots the distribution of 101 output current measurements 198 in a specification passing set of output current measurements. The 101 output current measurements of the fourth embodiment are in a specification range 200 between a lower specification level (LSL) 202 of 11.2 mA and an upper specification level (USL) 110 of 12.5 mA.

The distribution of the output current measurements 198 for the 101 packaged semiconductor chips in the specification passing set of the fourth embodiment includes a bulk distribution 116 of output current measurements in a bulk distribution range 118. The bulk distribution range 118 is generally centered about the desired output current 112 of 11.5 mA. The distribution 198 also includes a smaller outlying distribution 122 above the bulk distribution 116.

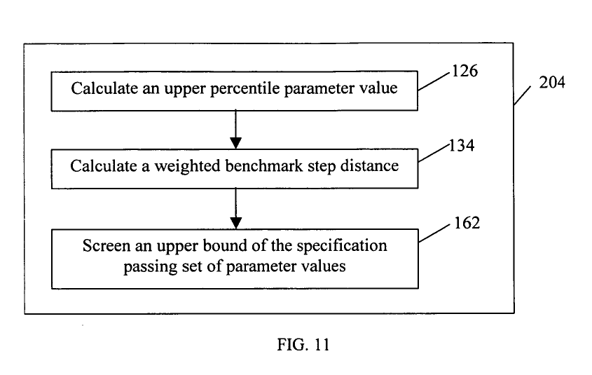

The steps of the fourth embodiment 204 are shown in FIG. 11. A first step in the fourth embodiment 204 is the calculation of an upper percentile measurement 126. Step 126 in the fourth embodiment 204 is the same as the calculation of the upper percentile measurement in the first embodiment shown in step 126 of FIG. 3. The upper percentile in the fourth embodiment is the 97^{th} percentile, and as shown in Table 5 below, the upper bound output current measurement at the 97^{th} percentile of the specification passing set in the fourth embodiment is 11.650 mA.

TABLE 5

| Percentile | Upper Bound | Upper Bound | Upper Bound Step Distance | |
|---|---|---|---|---|
| Rank | Output Current | Step Distance | Greater Than Weighted | Removed from |
| (%) | Measurement (mA) | (μA) | Benchmark Step Distance? | Specification Passing Set? |
| 97.0 | 11.650 | 20 | No | No |
| 98.0 | 11.670 | 20 | No | No |
| 99.0 | 11.690 | 390 | Yes | No |
| 100.0 | 12.080 | | | Yes |

The lower percentile in the fourth embodiment is 0%. FIG. 10 shows the zero percentile output current measurement 128 of 11.327 mA in the distribution 198.

With reference to FIG. 11, the next step in the fourth embodiment is the calculation of a weighted benchmark step distance 134. Step 134 of the fourth embodiment 204 may be the same as the calculation of a weighted benchmark step distance 134 in the first embodiment shown in FIG. 4 (or may be the same as step 134 in other embodiments). Referring now to Table 5 and to FIG. 4, the benchmark range distance in the fourth embodiment is calculated 136 by subtracting the 97th percentile measurement (e.g., 11.650 mA) from the zero percentile measurement (e.g., 11.327 mA). The resulting benchmark range distance of the fourth embodiment is 323 μA.

In FIG. 4, the bulk distribution population size in the fourth embodiment is calculated 140 by subtracting the number of measurements above the 97th percentile (e.g., 3) and below the zero percentile (e.g., 0) from the number of measurements in the specification passing set (e.g., 101 measurements). Thus, the bulk distribution population size of the fourth embodiment is 98.

In FIG. 4, the calculation of the benchmark step distance 142 in the fourth embodiment is performed by dividing the benchmark range distance of 323 μA by the bulk distribution population size of 98. The benchmark step distance in the fourth embodiment is therefore 3.296 μA. The benchmark step distance is multiplied 144 by a step weighting number of 10 to define a weighted benchmark step distance of 32.96 μA.

As shown in FIG. 11, the next step in the method of the fourth embodiment 204 is the screening of an upper bound of the specification passing set of output current measurements 162. Step 162 of the fourth embodiment is the same as step 162 of the first embodiment, as shown in FIG. 6.

With combined reference to FIG. 6 and Table 5 (above), results of performing step 162 in accordance with the fourth embodiment are shown in Table 5. In Table 5, it is seen that through multiple step iterations of steps 168-172 in FIG. 6, that the upper bound step distance is smaller than the weighted benchmark step distance of 32.9 μA for the distances between the 97th percentile, the 98th percentile, and the 99th percentile. However, in a third loop iteration of steps 168-172 in the fourth embodiment, the step distance between the 99^{th} percentile measurement of 11.690 mA and the 100^{th} percentile measurement of 12.080 mA is calculated 168 to be 390 μA (see Table 5). Because the step distance of 390 μA is greater than the weighted benchmark step distance of 32.96 μA, step 174 in FIG. 6 is performed next. The right-most column of Table 5 identifies the single test measurement of the semiconductor chip to be removed from the specification passing set of semiconductor chips in the fourth embodiment. As shown in Table 5, only the single semiconductor chip having an output current measurement at the 100^{th} percentile has an output current test measurement of 12.080 mA or greater. Thus, the semiconductor chip at the 100^{th} percentile is removed from the specification passing set of semiconductor chips in the fourth embodiment.

In the fourth embodiment, one packaged semiconductor chip is screened from the upper bound of the specification passing set of packaged semiconductor chips. The 100 remaining packaged semiconductor chips in the specification passing set of packaged semiconductor chips form a quality passing set of packaged semiconductor chips.

One of the advantages provided in the fourth embodiment is that two of the semiconductor chips (e.g., see the 98^{th} percentile and the 99^{th} percentile in Table 5) are above the upper percentile, but were included in the quality set of semiconductor chips of the fourth embodiment. The two chips at the 98^{th} and 99^{th} percentile in the fourth embodiment were identified as having test measurements within an acceptable range of the bulk distribution of test measurements. The inclusion of these chips in the quality passing set of semiconductor chips may provide a higher yield and increased revenue.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of forming a quality passing set of semiconductor products, comprising:
testing a parameter in a plurality of semiconductor products;
forming a specification passing set of semiconductor products from semiconductor products in the plurality of semiconductor products having a parameter value of the parameter within a specification range; and
screening quality risk semiconductor products from the specification passing set of semiconductor products to form the quality passing set of semiconductor products, comprising:
calculating an upper percentile parameter value, the upper percentile parameter value being at an upper percentile of the specification passing set of parameter values;
calculating a lower percentile parameter value, the lower percentile parameter value being at a lower percentile of the specification passing set of parameter values,
calculating a weighted benchmark step distance, comprising:
calculating a bulk distribution range distance, wherein the bulk distribution range distance is a distance between the upper percentile parameter value and the lower percentile parameter value,
calculating a bulk distribution population size,
calculating a benchmark step distance, wherein the benchmark step distance is the bulk distribution range distance divided by the bulk distribution population size, and
multiplying the benchmark step distance by a step weighting number to define the weighted benchmark step distance; and
screening a lower bound of the specification passing set of parameter values, comprising:
forming a set of lower bound parameter values comprising parameter values of the specification passing set of parameter values that are at and below the lower percentile,
sorting the set of lower bound parameter values from a largest lower bound parameter value to a smallest lower bound parameter value, and
for each lower bound parameter value in the set of lower bound parameter values, beginning with the largest lower bound parameter value:
calculating a lower bound step distance between the each lower bound parameter value and a next smaller lower bound parameter value, and
removing semiconductor products having a parameter value equal to or less than the next smaller lower bound parameter value from the specification passing set of semiconductor products if the lower bound step distance is greater than the weighted benchmark step distance, and
screening an upper bound of the specification passing set of parameter values, comprising:
forming a set of upper bound parameter values comprising parameter values of the specification passing set of parameter values that are at and above the upper percentile,
sorting the set of upper bound parameter values from a smallest upper bound parameter value to a largest upper bound parameter value, and
for each upper bound parameter value in the set of upper bound parameter values, and beginning with the smallest upper bound parameter value:
calculating an upper bound step distance between the each upper bound parameter value and a next larger upper bound parameter value, and
removing semiconductor products having a parameter value equal to or greater than the next larger upper bound parameter value from the specification passing set of semiconductor products if the upper bound step distance is greater than the weighted benchmark step distance.

2. The method of 1, wherein the specification range is a range of values between a preselected upper specification limit and a preselected lower specification limit.

3. The method of 1, wherein a lower percentile distance between the lower percentile and 0% is different than an upper percentile distance between the upper percentile and 100%.

4. The method of 1, wherein the lower percentile is 3% and the upper percentile is 97%.

5. The method of 1, wherein the upper percentile is the lower percentile subtracted from 100%.

6. The method of 1, wherein the upper percentile is 100%.

7. The method of 1, wherein the lower percentile is 0%.

8. The method of 1, wherein the testing is a final chip test.

9. The method of 1, wherein the testing is a wafer test prior to wafer sort.

10. The method of 1, wherein the bulk distribution population size is a number of semiconductor products in the specification passing set of semiconductor products that have parameter values between the upper percentile parameter value and the lower percentile parameter value.

11. The method of 1, wherein the bulk distribution population size is a size of the specification passing set of semiconductor products multiplied by a difference of the lower percentile subtracted from the upper percentile.

12. The method of 1, wherein the step weighting number is a preselected number selected from the group consisting of 0, 10⁻³, 0.856, 1.0, 1.3, 10, and 100.

13. The method of 1, wherein the lower percentile and the upper percentile are preselected numbers.

14. A method of forming a quality passing set of semiconductor products, comprising:
testing a parameter in a plurality of semiconductor products;
forming a specification passing set of semiconductor products from semiconductor products in the plurality of semiconductor products having a parameter value of the parameter within a specification range; and
screening quality risk semiconductor products from the specification passing set of semiconductor products to form the quality passing set of semiconductor products, comprising:
calculating an upper percentile parameter value, the upper percentile parameter value being at an upper percentile of the specification passing set of parameter values;
calculating a lower percentile parameter value, the lower percentile parameter value being at a lower percentile of the specification passing set of parameter values,
calculating a weighted benchmark step distance, comprising:
calculating a bulk distribution set of parameter values, the bulk distribution set of parameter values comprising parameter values from the specification passing set that are in a range between the upper percentile parameter value and the lower percentile parameter value,
calculating a set of bulk distribution step distances, the set of bulk distribution step distances comprising distances between each parameter value in the set of bulk distribution parameter values and an adjacent parameter value also in the set of bulk distribution parameter values, and
wherein the weighted benchmark step distance is a largest step distance in the set of bulk distribution step distances multiplied by a step weighting number,
screening a lower bound of the specification passing set of parameter values, comprising:
forming a set of lower bound parameter values comprising parameter values of the specification passing set of parameter values that are at and below the lower percentile,
sorting the set of lower bound parameter values from a largest lower bound parameter value to a smallest lower bound parameter value, and
for each lower bound parameter value in the set of lower bound parameter values, beginning with the largest lower bound parameter value:
calculating a lower bound step distance between the each lower bound parameter value and a next smaller lower bound parameter value, and
removing semiconductor products having a parameter value equal to or less than the next smaller lower bound parameter value from the specification passing set of semiconductor products if the lower bound step distance is greater than the weighted benchmark step distance, and
screening an upper bound of the specification passing set of parameter values, comprising:
forming a set of upper bound parameter values comprising parameter values of the specification passing set of parameter values that are at and above the upper percentile,
sorting the set of upper bound parameter values from a smallest upper bound parameter value to a largest upper bound parameter value; and
for each upper bound parameter value in the set of upper bound parameter values, and beginning with the smallest parameter value:
calculating an upper bound step distance between the each upper bound parameter value and a next larger upper bound parameter value, and
removing semiconductor products having a parameter value equal to or greater than the next larger upper bound parameter value from the specification passing set of semiconductor products if the upper bound step distance is greater than the weighted benchmark step distance.

15. A method of screening quality risk semiconductor products, comprising
testing a parameter in a plurality of semiconductor products;
forming a specification passing set of semiconductor products from semiconductor products in the plurality of semiconductor products having a parameter value of the parameter within a specification range;
calculating a lower percentile parameter value in the specification passing set of parameter values, the lower percentile parameter value being at a lower percentile of the specification passing set of parameter values;
calculating a benchmark step distance; and
screening a lower bound of the specification passing set of parameter values, comprising:
forming a set of lower bound parameter values comprising parameter values of the specification passing set of parameter values that are at and below the lower percentile,
sorting the set of lower bound parameter values from a largest lower bound parameter value to a smallest lower bound parameter value, and
for each lower bound parameter value in the set of lower bound parameter values, beginning with the largest lower bound parameter value:
calculating a lower bound step distance between the each lower bound parameter value and a next smaller lower bound parameter value, and
removing semiconductor products having a parameter value equal to or less than the next smaller lower bound parameter value from the specification passing set of semiconductor products if the lower bound step distance is greater than the weighted benchmark step distance.

16. The method of claim 15, wherein the benchmark step distance is a weighted benchmark step distance, and the weighted benchmark step distance is the benchmark step distance multiplied by a step weighting number.

17. The method of claim 15, further comprising screening an upper bound of the specification passing set of parameter values, comprising:
calculating an upper percentile parameter value, the upper percentile parameter value being at an upper percentile of the specification passing set of parameter values; forming a set of upper bound parameter values comprising parameter values of the specification passing set of parameter values that are at and above the upper percentile;
sorting the set of upper bound parameter values from a smallest upper bound parameter value to a largest upper bound parameter value; and
for each upper bound parameter value in the set of upper bound parameter values, and beginning with the smallest upper bound parameter value:
calculating an upper bound step distance between the each upper bound parameter value and a next larger upper bound parameter value, and
removing semiconductor products having a parameter value equal to or greater than the next larger upper bound parameter value from the specification passing set of semiconductor products if the upper bound step distance is greater than the weighted benchmark step distance.

18. The method of claim 15, wherein the calculating the benchmark step distance comprises:
calculating a bulk distribution range distance, wherein the bulk distribution range distance is the lower percentile parameter value subtracted from an upper percentile parameter value;
calculating a bulk distribution population size, wherein the bulk distribution population size is a size of the specification passing set of semiconductor products multiplied by a difference of the lower percentile subtracted from an upper percentile; and
wherein the benchmark step distance is the bulk distribution range distance divided by the bulk distribution population size.

19. The method of claim 15, wherein the calculating the benchmark step distance comprises:
calculating a bulk distribution set of parameter values, the bulk distribution set of parameter values comprising parameter values from the specification passing set that are in a range between an upper percentile parameter value and the lower percentile parameter value;
calculating a set of bulk distribution distances, the set of bulk distribution distances comprising distances between each parameter value in the set of bulk distribution distances and an adjacent parameter value also in the set of bulk distribution distances; and
wherein the benchmark step distance is a largest step distance in the set of bulk distribution step distances.

20. A method of screening quality risk semiconductor products, comprising
calculating an upper percentile parameter value in a specification passing set of parameter values, the upper percentile parameter value being at an upper percentile of the specification passing set of parameter values;
calculating a benchmark step distance; and
screening an upper bound of the specification passing set of parameter values, comprising:
forming a set of upper bound parameter values comprising parameter values of the specification passing set of parameter values that are at and above the upper percentile;
sorting the set of upper bound parameter values from a smallest to a largest, and
for each upper bound parameter value in the set of upper bound parameter values, and beginning with the smallest upper bound parameter value:
calculating an upper bound step distance between the each upper bound parameter value and a next larger upper bound parameter value, and
removing semiconductor products having a parameter value equal to or greater than the next larger upper bound parameter value from the specification passing set of semiconductor products if the upper bound step distance is greater than the weighted benchmark step distance.

21. The method of claim 20, wherein the benchmark step distance is a weighted benchmark step distance, and the weighted benchmark step distance is the benchmark step distance multiplied by a step weighting number.

22. The method of claim 20, further comprising screening a lower bound of the specification passing set of parameter values, comprising:
calculating a lower percentile parameter value, the lower percentile parameter value being at a lower percentile of the specification passing set of parameter values;
forming a set of lower bound parameter values comprising parameter values of the specification passing set of parameter values that are at and below the lower percentile;
sorting the set of lower bound parameter values from a largest lower bound parameter value to a smallest lower bound parameter value; and
for each lower bound parameter value in the set of lower bound parameter values, and beginning with the largest upper bound parameter value:
calculating an lower bound step distance between the each lower bound parameter value and a next smaller lower bound parameter value, and
removing semiconductor products having a parameter value equal to or less than the next smaller upper bound parameter value from the specification passing set of semiconductor products if the lower bound step distance is greater than the benchmark step distance.

23. The method of claim 20, wherein the calculating the benchmark step distance comprises:
calculating a bulk distribution range distance, wherein the bulk distribution range distance is a lower percentile parameter value subtracted from the upper percentile parameter value;
calculating a bulk distribution population size, wherein the bulk distribution population size is a size of the specification passing set of semiconductor products multiplied by a difference of a lower percentile subtracted from the upper percentile; and
wherein the benchmark step distance is the bulk distribution range distance divided by the bulk distribution population size.

24. The method of claim 20, wherein the calculating the benchmark step distance comprises:
calculating a bulk distribution set of parameter values, the bulk distribution set of parameter values comprising parameter values from the specification passing set that are in a range between the upper percentile parameter value and a lower percentile parameter value;
calculating a set of bulk distribution distances, the set of bulk distribution distances comprising distances between each parameter value in the set of bulk distribution distances and an adjacent parameter value also in the set of bulk distribution distances; and
wherein the benchmark step distance is a largest step distance in the set of bulk distribution step distances.
